(19) United States
(12) Patent Application Publication
(10) Pub. No.: US 2026/0253926 A1
(43) Pub. Date: Aug. 27, 2026

(54) FUEL CELL SYSTEM

(71) Applicant: TOYOTA JIDOSHA KABUSHIKI KAISHA, Toyota-shi (JP)

(72) Inventors: Tohru ODA, Toyota-shi (JP); Jin Ito, Nagoya-shi (JP)

(73) Assignee: TOYOTA JIDOSHA KABUSHIKI KAISHA, Toyota-shi (JP)

(21) Appl. No.: 19/426,577

(22) Filed: Dec. 19, 2025

(30) Foreign Application Priority Data
Feb. 26, 2025 (JP) 2025-028794

(51) Int. Cl. H01M 8/04223; H01M 8/04492; H01M 8/04746

(52) U.S. Cl. CPC H01M 8/04231; H01M 8/045; H01M 8/04753

(57) ABSTRACT

The present disclosure relates to a fuel cell system. The fuel cell system includes a fuel gas system, an oxidant gas system, and a control device. The control device is configured to perform purge control. In the purge control, purging on the anode side is started first, and then purging on the cathode side is started.

### CROSS-REFERENCE TO RELATED APPLICATION

This application claims priority to Japanese Patent Application No. 2025-028794 filed on Feb. 26, 2025. The disclosure of the above-identified application, including the specification, drawings, and claims, is incorporated by reference herein in its entirety.

### BACKGROUND

### 1. Technical Field

The present disclosure relates to fuel cell systems.

### 2. Description of Related Art

Japanese Unexamined Patent Application Publication No. 2024-106454 (JP 2024-106454 A) discloses a fuel cell system in which the purge time and purge start timing for the anode are set based on the cathode water content.

### SUMMARY

When purging is performed as disclosed in JP 2024-106454 A, the cathode dries first, and therefore liquid water containing impurities on the anode side easily moves to the cathode side, making the electrolyte membrane susceptible to degradation.

An object of the present disclosure is to reduce the likelihood of degradation of the electrolyte membrane in a fuel cell system that performs purging.

The present specification discloses a fuel cell system including a fuel gas system, an oxidant gas system, and a control device. The control device is configured to perform purge control. In the purge control, purging on the anode side is started first, and then purging on the cathode side is started.

In the purge control, the purging on the cathode side may be started after the anode water content has become less than or equal to a predetermined value.

In the purge control, the purging on the cathode side may be started after a predetermined period of time has elapsed since the start of the purging on the anode side.

In the fuel cell system of the present disclosure, purging on the anode side is started first, and then purging on the cathode side is started. Therefore, it becomes more difficult for liquid water on the anode side to move, thereby reducing the likelihood of degradation of the electrolyte membrane.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing the configuration of a fuel cell system 10; and

FIG. 2 is a flowchart illustrating the flow of purge control S10.

### DETAILED DESCRIPTION OF EMBODIMENTS

In a fuel cell system, a purge is performed once power generation ends. However, immediately after power generation ends, the cathode is wet from upstream to downstream with water produced during power generation, and on the anode side, the water diffuses from the wetted region downstream of the cathode into the anode, making the anode wet. Accordingly, under any power generation conditions, the amount of liquid water is smaller in the anode than in the cathode.

Oxygen that has permeated from the cathode to the anode combines with hydrogen, generating hydrogen peroxide. Radicals are thus produced, which significantly decompose components of the electrolyte membrane in the anode. These substances are concentrated in the small amount of liquid water, creating a more severe corrosion environment. As a result, the anode contains many impurities (for example, Fe ions derived from a stainless steel separator) in the small amount of liquid water, while the cathode contains fewer impurities (for example, the above Fe ions) in the larger amount of liquid water.

The anode and the cathode are purged in this state. When the anode and the cathode are purged simultaneously, the cathode is purged with dry air at a high flow rate, while the anode is purged with circulated, humidified hydrogen at a low flow rate (for fuel efficiency) . Accordingly, the cathode becomes dry first, and liquid water diffuses in the reverse direction from the anode to the cathode. In this reverse diffusion of liquid water, impurities (for example, the aforementioned Fe ions) are incorporated into the electrolyte membrane, thereby promoting the Fenton reaction that generates radicals from hydrogen peroxide, and thus accelerating membrane degradation.

In view of the foregoing, the present disclosure first dries the anode and then, after a delay, dries the cathode, thereby suppressing the occurrence of the aforementioned issue and reducing the likelihood of degradation of the electrolyte membrane. More specific embodiments for this purpose will be described below.

The gas used for the purge (drainage) described below may be, for example, oxidant gas, fuel gas, or nitrogen gas. The gas used for purging the cathode may be, for example, oxidant gas or nitrogen gas. The gas used for purging the anode may be, for example, fuel gas or nitrogen gas.

The fuel cell system of the present disclosure may be mounted on a moving object such as a vehicle, or may be mounted in a generator that supplies electric power externally. The vehicle may be, for example, a fuel cell electric vehicle. Examples of moving objects include trains, ships, and aircraft, in addition to vehicles. The fuel cell system of the present disclosure may be mounted on a moving object (such as a vehicle) that can also run on power from a secondary battery. The moving object may include a drive unit such as a motor, an inverter, or a hybrid control system. The hybrid control system may be one that is configured to cause the moving object to travel using both the output of the fuel cell and the power of the secondary battery.

In the present specification, the reactant gas supplied to the anode is fuel gas, and the reactant gas supplied to the cathode is oxidant gas. The fuel gas is a gas mainly containing hydrogen, and may be pure hydrogen. The oxidant gas is a gas containing oxygen, and may be, for example, oxygen, air, or dry air.

### 1. Configuration Example of Fuel Cell System

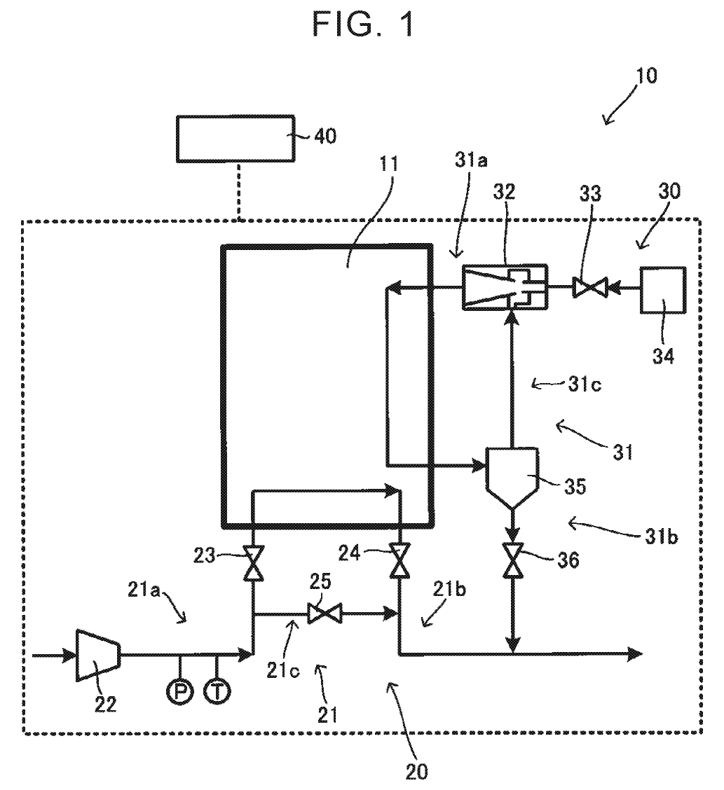

FIG. 1 is a schematic diagram showing one example of the configuration of a fuel cell system 10 according to the present disclosure. The fuel cell system 10 shown in FIG. 1 includes a fuel cell 11, an oxidant gas system 20, a fuel gas system 30, an impedance measuring device (not shown), and a control device (fuel cell-electronic control unit (FC-ECU)) 40.

For convenience, the cooling system is omitted in FIG. 1.

### 1.1. Fuel Cell

The fuel cell 11 may have one single cell, which is the smallest unit of power generation, or may be a fuel cell stack (also referred to as "FC stack" or "stack") in which multiple single cells are stacked together. In the present disclosure, both a single cell and a fuel cell stack are collectively referred to as "fuel cell." The number of stacked single cells is not particularly limited and may range from, for example, two to several hundred.

A single cell of the fuel cell typically includes a membrane-electrode-gas diffusion layer assembly. The membrane-electrode-gas diffusion layer assembly includes an anode-side gas diffusion layer, an anode catalyst layer, an electrolyte membrane, a cathode catalyst layer, and a cathode-side gas diffusion layer in this order.

The cathode (oxidant electrode) includes the cathode catalyst layer and the cathode-side gas diffusion layer. The anode (fuel electrode) includes the anode catalyst layer and the anode-side gas diffusion layer. The cathode catalyst layer and the anode catalyst layer are collectively referred to as "catalyst layers."

Each catalyst layer may include, for example, a catalyst metal that promotes an electrochemical reaction, an electrolyte having proton conductive properties, and a support having electron conductive properties. Examples of the catalyst metal include platinum (Pt) and alloys of Pt and another metal (for example, platinum-cobalt and platinum-nickel alloys). The electrolyte may be a fluororesin. For example, a Nafion solution may be used as a fluororesin.

The catalyst metal is supported on the support, and in each catalyst layer, the support on which the catalyst metal is supported (catalyst-supported support) and the electrolyte may be mixed together. Examples of support materials on which the catalyst metal is supported include carbon materials such as commercially available carbon.

The cathode-side gas diffusion layer and the anode-side gas diffusion layer are collectively referred to as "gas diffusion layers." Each gas diffusion layer may be, for example, an electrically conductive member having gas permeable properties. Examples of the electrically conductive member include carbon porous materials such as carbon cloth and carbon paper, and metallic porous materials such as metal mesh and foamed metal.

The electrolyte membrane may be a solid polymer electrolyte membrane. Examples of the solid polymer electrolyte membrane include fluorine-based electrolyte membranes such as a thin film of perfluorosulfonic acid containing moisture, and hydrocarbon-based electrolyte membranes. Examples of the electrolyte membrane include a Nafion membrane (manufactured by DuPont).

The single cell may include, as needed, two separators that sandwich the membrane-electrode-gas diffusion layer assembly on both sides. One of the two separators is an anode-side separator, and the other is a cathode-side separator. In the present disclosure, the anode-side separator and the cathode-side separator are collectively referred to as "separators."

Each separator may have holes forming manifolds, such as supply holes and discharge holes, through which fluids such as reactant gases and a cooling medium circulate in the stacking direction of the single cells. As the cooling medium, coolant such as a mixed solution of ethylene glycol and water may be used to inhibit freezing at low temperatures. Alternatively, air for cooling may be used as the cooling medium.

The supply holes may include a fuel-gas supply hole, an oxidant-gas supply hole, and a cooling-medium supply hole. The discharge holes may include a fuel-gas discharge hole, an oxidant-gas discharge hole, and a cooling-medium discharge hole.

Each separator may have a reactant gas flow channel on the surface that faces the corresponding gas diffusion layer. Each separator may also have a cooling medium flow channel on the surface opposite to the surface facing the corresponding gas diffusion layer, in order to keep the temperature of the fuel cell constant.

Each separator may be an electrically conductive member that is impermeable to gas. Examples of the electrically conductive member include dense carbon obtained by compressing carbon to make it gas-impermeable, and metal plates formed by press-forming a metal (such as iron, aluminum, or stainless steel). Each separator may have a current-collecting function.

In view of the effect of Fe ions mentioned above, the present disclosure is particularly effective when iron or stainless steel is used as the material of the separators.

The fuel cell 11 may include manifolds such as inlet manifolds communicating with the respective supply holes and outlet manifolds communicating with the respective discharge holes.

Examples of the inlet manifolds include an anode inlet manifold, a cathode inlet manifold, and a cooling medium inlet manifold.

Examples of the outlet manifolds include an anode outlet manifold, a cathode outlet manifold, and a cooling medium outlet manifold.

### 1.2. Oxidant Gas System

The oxidant gas system 20 supplies oxidant gas to the fuel cell 11 and discharges off-gas from the fuel cell 11. The oxidant gas system 20 includes, in an oxidant-side flow passage 21, an air compressor 22, a pressure sensor P, a temperature sensor T, an inlet shutoff valve 23, a pressure control valve 24, and a bypass valve 25.

The oxidant-side flow passage 21 includes an oxidant-gas supply passage 21a, an oxidant off-gas discharge passage 21b, and a bypass passage 21c.

Oxidant-Gas Supply Passage 21a and Components Provided Therein

The oxidant-gas supply passage 21a is a passage that supplies oxidant gas to the fuel cell 11, and connects the outside of the fuel cell system 10 to the cathode inlet of the fuel cell 11. The oxidant-gas supply passage 21a enables supply of oxidant gas from the air compressor 22 to the cathode of the fuel cell. The cathode inlet may be, for example, an oxidant-gas supply hole or a cathode inlet manifold.

The oxidant-gas supply passage 21a includes the air compressor 22, the pressure sensor P, the temperature sensor T, and the inlet shutoff valve 23.

The air compressor 22 includes a bearing, a rotor, and a housing. The air compressor 22 is electrically connected to the control device 40, and the rotational speed of the rotor is controlled in accordance with a control signal from the control device 40.

The inlet shutoff valve 23 is a valve provided downstream of the air compressor 22, and is electrically connected to the control device 40. When the inlet shutoff valve 23 is opened by the control device 40, oxidant gas is supplied to the cathode of the fuel cell 11. The flow rate of the oxidant gas supplied to the cathode may be adjusted by controlling the opening degree of the inlet shutoff valve 23.

The pressure sensor P, the temperature sensor T, and a flow rate sensor (not shown) may be disposed downstream of the air compressor 22 in the oxidant-gas supply passage 21a.

The pressure sensor P measures the pressure value of the cathode and is electrically connected to the control device 40. The control device 40 acquires the pressure value of the cathode measured by the pressure sensor P.

The temperature sensor T measures the temperature of the cathode and is electrically connected to the control device 40. The control device 40 acquires the temperature of the cathode measured by the temperature sensor T.

The flow rate sensor measures the flow rate of the oxidant gas and is electrically connected to the control device 40. The control device 40 acquires the flow rate of the oxidant gas measured by the flow rate sensor.

### Oxidant Off-Gas Discharge Passage 21b and Components Provided Therein

The oxidant off-gas discharge passage 21b connects the cathode outlet of the fuel cell 11 to the outside of the fuel cell system 10. The oxidant off-gas discharge passage 21b allows oxidant off-gas, which is oxidant gas discharged from the cathode of the fuel cell 11, to be discharged to the outside of the fuel cell system 10. The cathode outlet may be, for example, an oxidant-gas discharge hole or a cathode outlet manifold. The pressure control valve 24 may be disposed in the oxidant off-gas discharge passage 21b.

The pressure control valve 24 is electrically connected to the control device 40. When the pressure control valve 24 is opened by the control device 40, oxidant off-gas, namely oxidant gas that has undergone reaction, is discharged from the oxidant off-gas discharge passage 21b to the outside of the fuel cell system 10. The pressure of the oxidant gas supplied to the cathode (cathode pressure) may be adjusted by controlling the opening degree of the pressure control valve 24. The oxidant off-gas may have the same components as the oxidant gas. The oxidant off-gas may be, for example, oxygen, air, or dry air, and may contain water vapor etc.

### Bypass Passage 21c and Components Provided Therein

The bypass passage 21c connects the oxidant-gas supply passage 21a and the oxidant off-gas discharge passage 21b, and serves as a passage that bypasses the fuel cell 11. The bypass passage 21c branches off from the oxidant-gas supply passage 21a at a branch point located downstream of the air compressor 22 in the oxidant-gas supply passage 21a, bypasses the fuel cell 11, and merges with the oxidant off-gas discharge passage 21b downstream of the pressure control valve 24 in the oxidant off-gas discharge passage 21b.

The bypass valve 25 may be disposed in the bypass passage 21c. The bypass valve 25 may be, for example, a valve whose opening degree is adjustable, and may be a three-way valve for oxidant gas. When the bypass valve 25 is a three-way valve for oxidant gas, the bypass valve 25 may be disposed at the branch point at the most upstream end of the bypass passage 21c, and may also serve as an oxidant-gas inlet shutoff valve.

The bypass valve 25 is electrically connected to the control device 40. When the bypass valve 25 is opened by the control device 40, at least part of the oxidant gas can be supplied to the oxidant off-gas discharge passage 21b while bypassing the fuel cell 11. When the bypass valve 25 is a three-way valve for oxidant gas, the control device 40 operates the bypass valve 25 such that the flow of oxidant gas is switched from the oxidant-gas supply passage 21a to the bypass passage 21c, by closing the valve on the downstream side of the oxidant-gas supply passage 21a and opening the valve on the bypass passage 21c side, for example, when oxidant gas need not be supplied to the fuel cell 11. The entire flow of oxidant gas can thus be supplied to the oxidant off-gas discharge passage 21b.

### Others

The oxidant gas system 20 may include a cooler (intercooler) downstream of the air compressor 22 in the oxidant-gas supply passage 21a. The cooler may be disposed downstream of the air compressor 22 and upstream of the branch point to the bypass passage 21c in the oxidant-gas supply passage 21a.

The cooler may exhibit a cooling function by circulating a cooling medium of the cooling system inside and outside the cooler.

The oxidant gas system 20 may also include a humidifier disposed downstream of the air compressor 22 in the oxidant-gas supply passage 21a. The humidifier may be disposed downstream of the air compressor 22 and downstream of the branch point to the bypass passage 21c in the oxidant-gas supply passage 21a.

The humidifier may be disposed across the oxidant-gas supply passage 21a and the oxidant off-gas discharge passage 21b.

### 1.3. Fuel Gas System

The fuel gas system 30 supplies fuel gas to the fuel cell 11, discharges off-gas from the fuel cell 11, and circulates part of the off-gas. The fuel gas system 30 includes a fuel gas-side passage 31, an ejector 32, an inlet shutoff valve (LSV or injector (INJ)) 33, a medium-pressure sensor (medium-pressure hydrogen sensor) 34, an anode gas-liquid separator 35, and an exhaust/drain valve 36. The fuel gas may be supplied by, for example, a fuel tank, and specific examples include a liquid hydrogen tank and a compressed hydrogen tank.

The fuel gas-side passage 31 includes a fuel-gas supply passage 31a, a fuel off-gas discharge passage 31b, and a circulation passage 31c.

### Fuel-Gas Supply Passage 31a and Components Provided Therein

The fuel-gas supply passage 31a connects a fuel-gas supply unit such as a fuel tank to the anode inlet of the fuel cell 11. The fuel-gas supply passage 31a enables supply of hydrogen-containing fuel gas to the anode of the fuel cell 11. The anode inlet may be, for example, a fuel-gas supply hole or an anode inlet manifold.

The ejector 32 may be disposed at the junction between the fuel-gas supply passage 31a and the circulation passage 31c.

The inlet shutoff valve 33 may be disposed upstream of the ejector 32 in the fuel-gas supply passage 31a. The inlet shutoff valve 33 is electrically connected to the control device 40. When the inlet shutoff valve 33 is opened by the control device 40, fuel gas is supplied to the anode of the fuel cell 11. The flow rate of the fuel gas supplied to the anode may be adjusted by controlling the opening degree of the inlet shutoff valve 33. The inlet shutoff valve 33 may be, for example, a linear solenoid valve or an injector.

The medium-pressure sensor 34 may be disposed upstream of the inlet shutoff valve 33 in the fuel-gas supply passage 31a. The medium-pressure sensor 34 measures the pressure value of the anode and is electrically connected to the control device 40. The control device 40 acquires the pressure value of the anode measured by the medium-pressure sensor 34.

### Fuel Off-gas Discharge Passage 31b and Components Provided Therein

The fuel off-gas discharge passage 31b connects the anode outlet of the fuel cell 11 to the outside of the fuel-cell system 10. The anode outlet may be, for example, a fuel-gas discharge hole or an anode outlet manifold. The fuel off-gas may include fuel gas that has passed through the anode without reacting, and moisture such as product water generated at the cathode that has reached the anode. The fuel off-gas may corrosive substances generated in the catalyst layer and the electrolyte membrane, and oxidant gas that may be supplied to the anode during purging.

The anode gas-liquid separator 35 is disposed at the branch point between the fuel off-gas discharge passage 31b and the circulation passage 31c. Gas separated by the anode gas-liquid separator 35 flows into the circulation passage 31c, and liquid separated by the anode gas-liquid separator 35 flows downstream in the fuel off-gas discharge passage 31b.

The exhaust/drain valve 36 may be disposed downstream of the anode gas-liquid separator 35 in the fuel off-gas discharge passage 31b. The exhaust/drain valve 36 is electrically connected to the control device 40, and the opening and closing of the exhaust/drain valve 36 are controlled by the control device 40.

### Circulation Passage 31c

The circulation passage 31c branches off from the fuel off-gas discharge passage 31b at a branch point (the anode gas-liquid separator 35), and merges with the fuel-gas supply passage 31a at a merging point (the ejector 32). The circulation passage 31c circulates the fuel off-gas within the fuel gas system 30 as circulation gas.

### 1.4. Impedance Measuring Device

The impedance measuring device is a device that measures the impedance of the anode, and a known device may be employed. The impedance measuring device is electrically connected to the control device 40, and is configured such that the control device 40 can acquire the measured impedance.

### 1.5. Control Device

The control device 40 includes, for example, a processing unit such as a central processing unit (CPU), storage devices such as a read-only memory (ROM) that stores control programs and control data processed by the CPU and a random access memory (RAM) that is used mainly as various work areas for control processing, and an input/output interface. The control device 40 may be a control unit such as a power control unit (PCU) or an electronic control unit (ECU).

The control device 40 may be electrically connected to an ignition switch installed in a vehicle. The control device 40 may be operable by an external power source even when the ignition switch is turned off.

One of the functions of the control device 40 is to calculate the anode water content based on the impedance acquired from the impedance measuring device. This function may be achieved by, for example, storing in advance a dataset indicating the relationship between the anode impedance and the anode water content, and referring to the dataset to obtain the water content of the anode in the fuel cell.

### 1.6. Others

The fuel cell system 10 may include a cooling system (not shown). The cooling system adjusts the temperature of the fuel cell 11. The cooling system has a cooling-medium passage through which a cooling medium circulates inside and outside the fuel cell 11. The cooling-medium passage communicates with a cooling-medium supply hole and a cooling-medium discharge hole provided in the fuel cell 11, allowing the cooling medium to circulate inside and outside the fuel cell 11.

A cooling-medium supply unit may be provided in the cooling-medium passage. The cooling-medium supply unit is electrically connected to the control device 40. The cooling-medium supply unit is driven in accordance with a control signal from the control device 40. The control device 40 controls the flow rate of the cooling medium supplied from the cooling-medium supply unit to the fuel cell 11. The temperature of the fuel cell 11 is thus controlled. Examples of the cooling-medium supply unit include a coolant pump. A radiator that dissipates heat of the cooling medium or a reserve tank that stores the cooling medium may be provided in the cooling-medium passage.

The fuel cell system 10 may include a battery. The battery (secondary battery) may be any rechargeable battery, and examples include conventionally known secondary batteries such as a nickel metal hydride secondary battery and a lithium-ion secondary battery. The secondary battery may include an energy storage element such as an electric double-layer capacitor, and may be formed by a plurality of such energy storage elements connected in series.

The secondary battery supplies power to components such as the air compressor. The secondary battery may be chargeable from a power source external to the vehicle, such as a household power source, or may be charged by the output of the fuel cell. The charging and discharging of the secondary battery may be controlled by the control device 40.

### 2. Purge Control

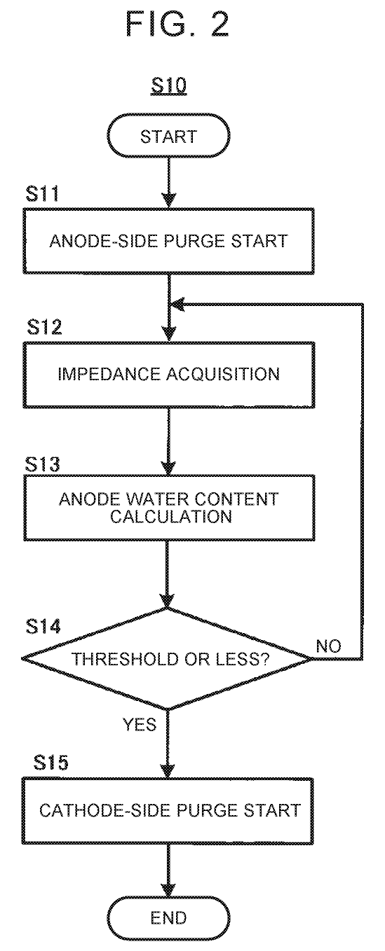

FIG. 2 illustrates the flow of purge control S10 according to one embodiment. In this embodiment, the purge control S10 is performed by the control device 40 based on information acquired by the control device 40 and control executed according to the results of calculation performed by a program using the acquired information. Each step of the purge control S10 will be described below.

### 2.1. Anode-Side Purge Start Step S11

In an anode-side purge start step S11, purging on the anode side is started. That is, when the purge control is initiated, purging on the anode side is first started.

### 2.2. Impedance Acquisition Step S12

In an impedance acquisition step S12, the anode impedance is acquired from the impedance measuring device.

### 2.3. Anode Water Content Calculation Step S13

In an anode water content calculation step S13, the anode water content is calculated from the anode impedance acquired in the impedance acquisition step S12.

### 2.4. Water Content Determination Step S14

In a water content determination step S14, it is determined whether the anode water content calculated in the anode water content calculation step S13 has become less than or equal to a predetermined value (threshold).

When the water content has not yet reached the threshold, the determination result is No, and the process returns to the impedance acquisition step S12. The anode purge continues during this time.

When the water content has become less than or equal to the threshold, the determination result is Yes, and the process proceeds to step S15. The anode purge continues during this time.

### 2.5. Cathode-Side Purge Start Step S15

In a cathode-side purge start step S15, purging on the cathode side is started. After this, once both the anode and cathode purges are completed, the purge control ends.

### 3. Effects etc.

According to this embodiment, purging is first started on the anode side and then started on the cathode side after the anode water content becomes less than or equal to the predetermined value (threshold). Therefore, movement of liquid water from the anode to the cathode is suppressed, and the likelihood of degradation of the electrolyte membrane can be reduced.

The above embodiment illustrates an example in which the purge on the cathode side is started after the anode water content is obtained, in order to achieve a more reliable effect. However, since the desired effect can also be achieved by starting the purge on the cathode side after the purge on the anode side has progressed to a certain extent, the present disclosure is not limited to the above example. For example, control may be performed such that the purge on the cathode side is started after a predetermined period of time has elapsed since the start of the purge on the anode side, based on data obtained in advance through testing etc.

What is claimed is:

1. A fuel cell system comprising:
a fuel gas system;
an oxidant gas system; and
a control device, wherein:
the control device is configured to perform purge control; and
in the purge control, purging on an anode side is started first, and then purging on a cathode side is started.

2. The fuel cell system according to claim 1, wherein, in the purge control, the purging on the cathode side is started after anode water content has become less than or equal to a predetermined value.

3. The fuel cell system according to claim 1, wherein, in the purge control, the purging on the cathode side is started after a predetermined period of time has elapsed since start of the purging on the anode side.
